(19) United States
(12) Patent Application Publication
(10) Pub. No.: US 2013/0120269 A1
(43) Pub. Date: May 16, 2013

(54) DESKTOP FOR A COMPUTER AND METHOD FOR PROVIDING SAME

(71) Applicant: ExoPC, Montreal (CA)

(72) Inventor: Martinoli Jean-Baptiste, St-Anaclet-de-Lessard (CA)

(73) Assignee: ExoPC, Montreal (CA)

(21) Appl. No.: 13/649,050

(22) Filed: Oct. 10, 2012

Related U.S. Application Data
(60) Provisional application No. 61/545,953, filed on Oct. 11, 2011.

(51) Int. Cl. G06F 3/023

(52) U.S. Cl. CPC G06F 3/023
USPC 345/168

(57) ABSTRACT

A desktop to be used in combination with a computer comprising a keyboard is disclosed, the desktop comprising an horizontal display comprising an interface for connecting the horizontal display to the computer and a display signal generating unit for generating a display signal to be provided to the horizontal display via the interface, the display signal for causing the horizontal display to display an indication of a zone on which the keyboard is to be positioned by a user and at least one element, wherein the at least one element is generated according to a context.

### CROSS-REFERENCE TO RELATED APPLICATIONS

This application claims priority of U.S. Patent Application No. 61/545,953, entitled “Desktop for a computer and method for providing same” that was filed on Oct. 11, 2011, the specification of which is hereby incorporated by reference.

### FIELD OF THE INVENTION

The invention relates to electronics. More precisely, this invention pertains to a desktop for a computer and a method for providing same.

### BACKGROUND OF THE INVENTION

Computers are widely used. They usually comprise a display used for providing a visual feedback to a user. While in some instances the display may have an important size, in many cases the display is relatively small which is a drawback since an amount of information displayed is then de facto limited.

Computers usually also comprise a keyboard used as an input/output device for enabling a user to interact with the computer.

There is a need for a device that will overcome at least one of the above-identified drawbacks.

Features of the invention will be apparent from review of the disclosure, drawings and description of the invention below.

### BRIEF SUMMARY OF THE INVENTION

According to a broad aspect of the invention, there is provided a desktop to be used in combination with a computer comprising a keyboard, the desktop comprising an horizontal display comprising an interface for connecting the horizontal display to the computer; a display signal generating unit for generating a display signal to be provided to the horizontal display via the interface, the display signal for causing the horizontal display to display an indication of a zone on which the keyboard is to be positioned by a user and at least one element, wherein the at least one element is generated according to a context.

In accordance with an embodiment of the desktop the display signal generating unit comprises computer-executable instructions stored in the computer.

In yet another embodiment of the desktop the horizontal display is a touch screen display.

In another embodiment of the desktop the interface is adapted for enabling a wire connection of the horizontal display to the computer.

In another embodiment of the desktop the interface is a USB interface.

In another embodiment of the desktop the interface is adapted for enabling a wireless connection of the horizontal display to the computer.

In one embodiment of the desktop the wireless connection is achieved using a WiFi network.

In yet another embodiment of the desktop the indication of a zone on which the keyboard is to be positioned by a user comprises one of a line defining the zone and a stippled line defining the zone.

In yet another embodiment of the desktop the indication of a zone on which the keyboard is to be positioned by a user is displayed for a given amount of time.

In yet another embodiment of the desktop the display signal further causes the horizontal display to display a zone on which a mouse is to be positioned.

In yet another embodiment of the desktop the at least one element is displayed in at least one of a plurality of zones located around the zone on which the keyboard is to be placed.

In another embodiment of the desktop the element is selected from a group consisting of pictures, schematics, videos, texts, animations, applications, RSS feeds.

In yet another embodiment of the desktop the context is associated with the execution of an application on the computer.

In another embodiment of the desktop the context is determined using at least one parameter.

In yet another embodiment of the desktop the at least one parameter is selected from a group consisting of a time of the day, a date, a mood of a user, a surrounding environment.

According to a broad aspect of the invention, there is provided a method for providing a user with a desktop for a computer comprising a keyboard, the method comprising providing an horizontal display, operatively connecting the horizontal display to the computer, displaying an indication of a zone on which the keyboard is to be positioned and at least one element, wherein the at least one element is generated according to a context.

In one embodiment the method further comprises displaying an indication of a zone on which a mouse is to be positioned.

According to another broad aspect of the invention, there is provided a method for displaying at least one element on a desktop operatively connected to a computer, the method comprising detecting a context; displaying at least one element on the desktop and an indication of a zone on which the keyboard is to be positioned, wherein the at least one element is generated according to a context.

In one embodiment of the method the detecting of the context comprises detecting an application being executed and obtaining input data from a user.

According to another broad aspect of the invention there is provided a computer-readable storage medium storing computer-executable instructions which, when executed, cause a computing device to perform a method for generating a display on a desktop, the desktop comprising an horizontal display operatively connected to a computer comprising a keyboard, the method comprising displaying a zone on which the keyboard is to be positioned; determining a context and displaying at least one element, wherein the at least one element is generated according to the context.

According to another broad aspect of the invention there is provided a computing device, the computing device comprising a display device; a central processing unit; a memory comprising at least one program, wherein the at least one program is stored in the memory and configured to be executed by the central processing unit, the at least one program comprising instructions for determining a context, instructions for generating a display signal to be provided to an horizontal display operatively connected to the central processing unit, the display signal for causing the horizontal display to display a zone on which the keyboard is to be positioned and at least one element wherein the at least one element is generated according to a context.

An advantage of the desktop disclosed is that a user will have readily access to pertinent data displayed on the horizontal display.

An advantage of the desktop disclosed is that it takes advantage of the field of view of a user and enables the providing of additional information in the field of view of the user.

An advantage of the desktop disclosed is that the desktop disclosed may, in some embodiments, help reduce the stress of users by providing the user with additional yet pertinent information.

An advantage of the desktop disclosed is that it may be used to reduce errors and therefore improve productivity by providing the user with additional yet pertinent information.

Another advantage of the desktop disclosed is that the desktop disclosed herein may provide a user with an immersive experience which can be enjoyable.

### BRIEF DESCRIPTION OF THE DRAWINGS

In order that the invention may be readily understood, embodiments of the invention are illustrated by way of example in the accompanying drawings.

FIG. 1 is a diagram which shows an embodiment of a desktop for a computer wherein the desktop is operatively connected to the computer.

FIG. 2 is a side view showing a part of an embodiment of a desktop for a computer.

FIG. 3 is a diagram which illustrates an embodiment of a desktop for a computer, wherein the desktop is used in combination with the keyboard and the mouse of the computer.

FIG. 4 is flowchart which shows an embodiment of a method for displaying at least one element on a desktop operatively connected to a computer; according to a first processing step a context is detected; according to a second processing step at least one element is displayed accordingly.

FIG. 5 is a flowchart which shows an embodiment of a detection of a context; according to a first processing step an application being executed is detected; according to a second processing step input data is obtained from a user.

FIG. 6 is a flowchart which shows an embodiment of a method for providing a desktop operatively connected to a computer.

FIG. 7 is a block diagram which shows an embodiment of a computer and a desktop operatively connected to the computer.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced. It will be understood that other embodiments may be made without departing from the scope of the invention disclosed.

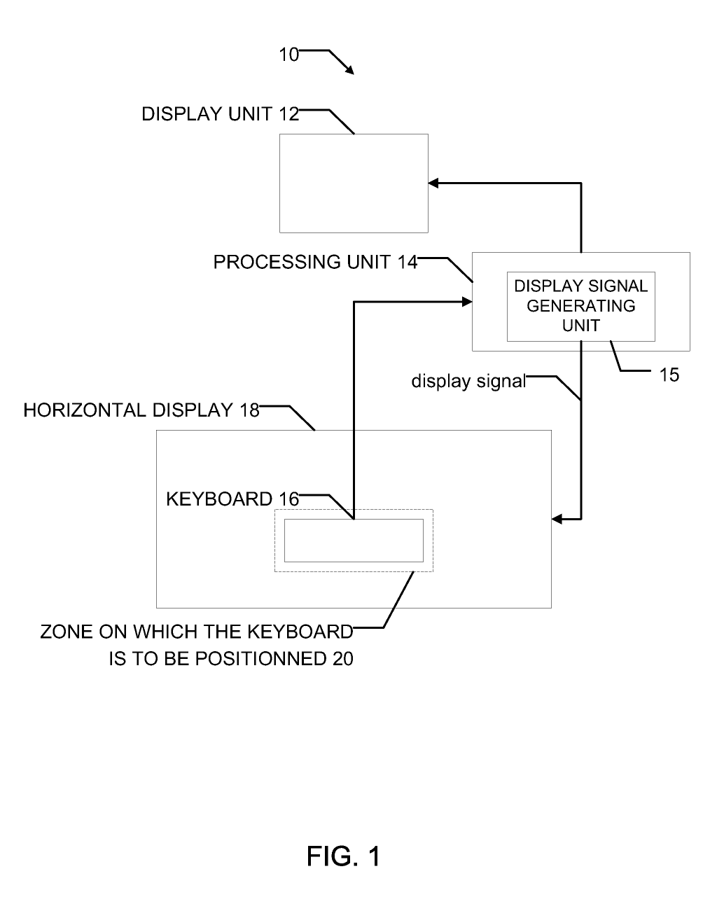

Now referring to FIG. 1, there is shown an embodiment of a desktop for a computer wherein the desktop is operatively connected to the computer.

More precisely, the system 10 disclosed in FIG. 1 comprises a computer comprising a display unit 12, a processing unit 14 and a keyboard 16.

The skilled addressee will appreciate that the computer may be of various types. For instance, the computer may be a PC compatible desktop computer. Alternatively, the computer may be a computer manufactured by Apple™, such as an iMac™. Moreover it should be appreciated that while it has been disclosed that the computer has a keyboard, the skilled addressee will appreciate that the computer may also have in addition any suitable input devices such as a mouse, a touchpad, a digital pen, a keypad, or the like.

In a preferred embodiment, the computer 11 comprises a keyboard and a mouse. Moreover and still in a preferred embodiment, the computer is a PC compatible running Windows™.

The system 10 disclosed in FIG. 1 further comprises a horizontal display 18.

It will be appreciated that the horizontal display 18 may be of various types.

In one embodiment the horizontal display 18 is a flat display panel having a size from 32 to 65 inches with a preferred size of 40 inches, which has a resolution of 1920×1080 pixels minimum and a 178 degrees minimum viewing angle. Still in a preferred embodiment, the horizontal display 18 comprises a screen protector or transparent glass to allow use of mouse and of objects on the display with no risk of damage. It will be appreciated by the skilled addressee that the flat display panel may be based on a LCD technology, on a LED technology, on a plasma technology, on an OLED technology, one an AMOLED technology or the like. Also it will be appreciated by the skilled addressee that auto stereoscopic 3D displays may be advantageously used for displaying information.

In one embodiment, the horizontal display 18 is model number C3266PW manufactured by 3M™. It is a multi-touch display that has a size of 32 inches.

In particular, it will be appreciated that while in one embodiment the horizontal display 18 is a multi-touch display, it will be appreciated that in an alternative embodiment, the horizontal display 18 is a single touch display.

Also it will be appreciated that in another alternative embodiment, part of the horizontal display 18 may be touch screen as further explained below.

Still referring to FIG. 1, it will be appreciated that the horizontal display 18 is operatively connected to the computer 11 via an interface not shown.

In a preferred embodiment, the horizontal display 18 is connected to the computer 11 via the processing unit 14. Still in a preferred embodiment, the connection is achieved using a connector for a second display or using a USB port on a video card of the processing unit 14. In the last embodiment, the interface is a USB interface.

It will be appreciated that the horizontal display 18 receives a display signal generated and provided by a display signal generating unit 15. In a preferred embodiment, the display signal generating unit is located in the computer. Still in a preferred embodiment, the display signal generating unit comprises computer-executable instructions.

The skilled addressee will appreciate that the display signal provided by the display signal generating unit 15 may be of various types depending on a communication protocol used.

The display signal provided by the display signal generating unit 15 causes the horizontal display 18 to display at least a zone on which the keyboard is to be positioned 20. The zone on which the keyboard is to be positioned 20 may be visually identified according to various embodiments.

In one embodiment, the zone 20 is shown using stippled lines outside a rectangular surface representing the zone where the keyboard is to be positioned 20. In an alternative embodiment, the zone on which the keyboard is to be positioned 20 can be visually identified using a line defining the zone. The skilled addressee will appreciate that various alternative embodiments may be possible.

It will be appreciated that the display of the zone on which the keyboard is to be positioned 20 is displayed for a given amount of time in accordance with one embodiment.

The display signal provided by the computer causes the horizontal display 18 to also display at least element, not shown, as explained further below.

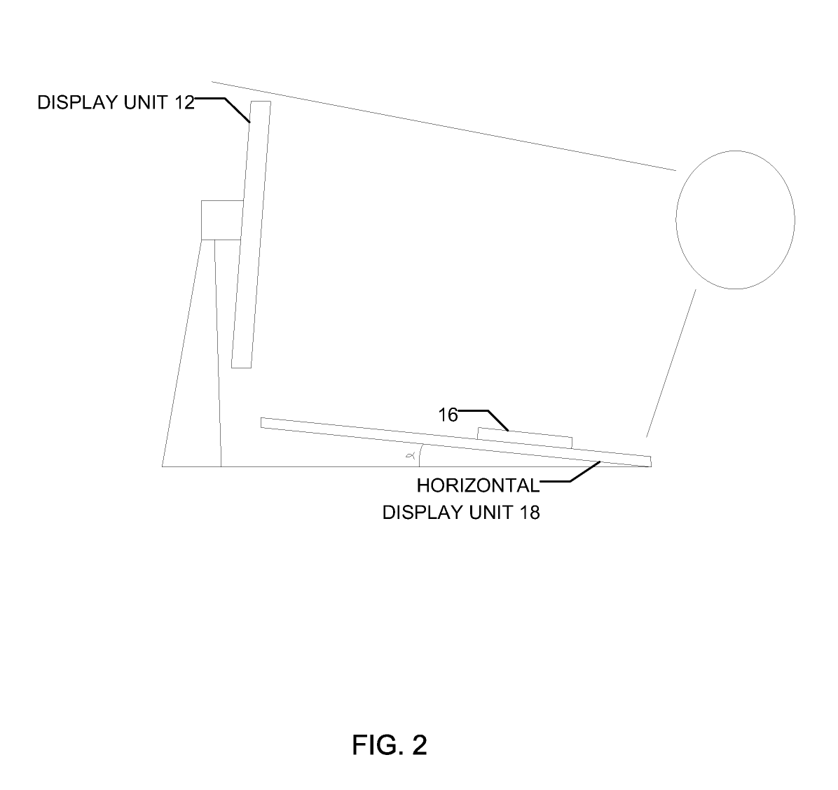

Now referring to FIG. 2, there is shown an embodiment of a desktop for a computer. The skilled addressee will appreciate that the processing unit 14 of the computer has not been shown for clarity purposes.

Still in this embodiment, the desktop is comprised of a horizontal display 18 on which the keyboard is placed. As shown, there is an angle alpha between the horizontal display 18 and a horizontal surface on which the horizontal display 18 is placed. The skilled addressee will therefore appreciate that the horizontal display 18 is not strictly horizontal but may be tilted a bit.

In a preferred embodiment, the angle alpha has a value equal to zero. In an alternative embodiment, the angle alpha has a value smaller than two degrees. A low value is key in order to avoid a mouse from sliding on the surface of the horizontal display 18.

Also it will be appreciated that in one embodiment the horizontal display 18 may be made of an ultra thin display which may be of great advantage. Such ultra thin display may be thin enough to be flexible.

Also it will be appreciated that the horizontal display 18 may be integrated in furniture which is of great advantage. It will also be appreciated by the skilled addressee that in an alternative embodiment legs may be added to the horizontal display 18.

In such embodiment, having an angle alpha equal to zero may facilitate the integration of the horizontal display 18 in the furniture.

It will be appreciated that the angle alpha may be created using various means such as an appropriate support for instance in order to improve the viewing angle.

Still referring to FIG. 2, it will be appreciated by the skilled addressee that a typical user may often watch the keyboard 16 while simultaneously watching the display unit 12. This is due to the fact that both the display unit 12 and the keyboard 16 are in the field of view of the user. Displaying information around the keyboard 16 is therefore of great advantage since such areas will still be within the field of view of the user. Moreover, since the keyboard 16 has to be put somewhere, putting the keyboard 16 on the horizontal display 18 is of great advantage.

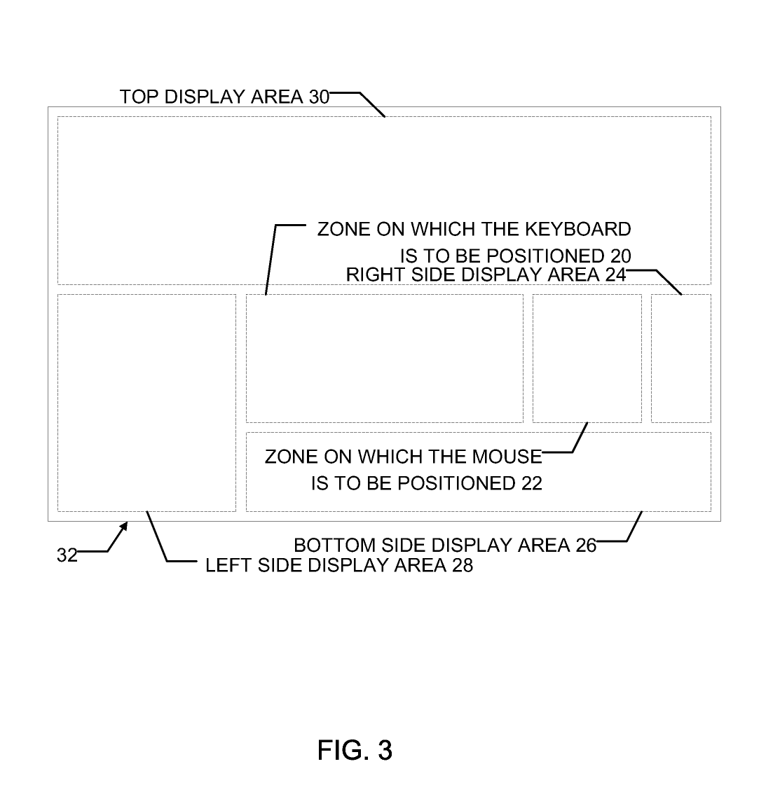

Now referring to FIG. 3, there is shown an embodiment of a desktop 32 for a computer wherein the desktop 32 is used in combination with a keyboard and a mouse.

The desktop 32 comprises a horizontal display 18 displaying a zone on which the keyboard is to be positioned 20. The horizontal display 18 further displays a zone on which the mouse is to be positioned 22. In a preferred embodiment, the zone on which the mouse is to be positioned 22 is located next to the zone on which the keyboard is to be positioned 20. The skilled addressee will appreciate that the size of the zone 20 and the zone 22 may vary depending on respectively the size of the keyboard and the size of the mouse as well as other parameters, such as the size of the horizontal display 18.

Still referring to FIG. 3, it will be appreciated that a top display area is provided above the zone on which the keyboard is to be placed 20 and the zone on which the mouse is to be positioned 22.

Still referring to FIG. 3, it will be appreciated that a right side display area 24 is provided on the right of the zone on which the mouse is to be positioned 22.

A left side display area 28 is provided on the left of the zone on which the keyboard is to be positioned 20 and a bottom side display area 26 is provided below the zone on which the keyboard is to be positioned 20 and the zone on which the mouse is to be positioned 22.

It will be appreciated that the size of each of the top display area 30, the right side display area 24, the bottom side display area 26 and the left side display area 28 may greatly vary depending on various elements or considerations.

Also while the zone on which the mouse is to be positioned 22 and the zone on which the keyboard is to be positioned 20 may be visually identified for the sake of showing them, the skilled addressee will appreciate that the partitioning of each of the top display area 30, the right side display area 24, the bottom side display area 26 and the left side display area 28 is not visually identified and is therefore invisible to a user in a preferred embodiment.

As mentioned above, in another alternative embodiment, part of the horizontal display 18 may be touchscreen. For instance in such embodiment the top display area 30, the left side display area 28 and the bottom side display area 26 could be manufactured as touchscreen areas while other areas may be manufactured as not touchscreen areas.

Moreover, it will be appreciated that at least one of the zone on which the keyboard is to be positioned 20, the zone on which the mouse is to be positioned 22, the top display area 30, the right side display area 24, the bottom side display area 26, the left side display area 28 may be used to display an element.

It will be appreciated that the element may be of various types. In fact, it will be appreciated that the element may be selected from a group consisting of applications, widgets, texts, pictures, schematics, videos, animations, RSS feeds or any combination thereof.

For instance and in accordance with one embodiment, the element may be weather data displayed. The element may be a clock and/or a calendar displayed, the element may alternatively comprise a visual notification of a receipt of new emails for instance. Alternatively, the element may be information displayed which is associated to social networks such as Twitter™, Google+™, Facebook™, LinkedIn™. The element may alternatively be an image which changes depending on time, season, etc. The element may further be game information displayed. The element may be a RSS feed displayed. The element may be system monitoring data displayed, such as an indication of a CPU load, an indication of a memory usage, etc. The element may alternatively be keyboard usage statistics or mouse usage statistics displayed. The element may alternatively be a color picker displayed, a charmap displayed, a post-it displayed, a clipboard visualizer, etc.

Alternatively, the element may be contextual information displayed on a procedure or on a workflow. The element may be a copy a web page or a part of a screen displayed, a slideshow. The element may alternatively comprise live dashboards, data and statistics displayed. The element may alternatively comprise alerts and alarms that are displayed. The element may alternatively be corporate news feeds displayed. The element may alternatively be a negative viewer, i.e. an X-ray viewer. Alternatively, the element may comprise stock quotes displayed. The element may alternatively be a satellite view. The element may alternatively be a view of plan displayed or graphics requiring a large display. The element may alternatively be a quick survey displayed, workflows displayed or request for approvals that are displayed. In such embodiment, a touchscreen display is recommended. Alternatively, the element may be a digital signature to be entered. In such embodiment, a touch screen display is also recommended. The element may alternatively be shortcuts that are displayed. In such embodiment, a touch screen display is also recommended. The element may alternatively be calculators and converters that are displayed. Alternatively, the element may be grids and size measurements for physical goods that are displayed. The element may be a physical procedure helper (gozilla glass may be required) i.e. areas where to put physical objects to help assembly for instance.

The skilled addressee will appreciate that the element may be therefore of various types which is of great advantage for the user. It will be further appreciated that the element may be dynamically changed depending on a parameter.

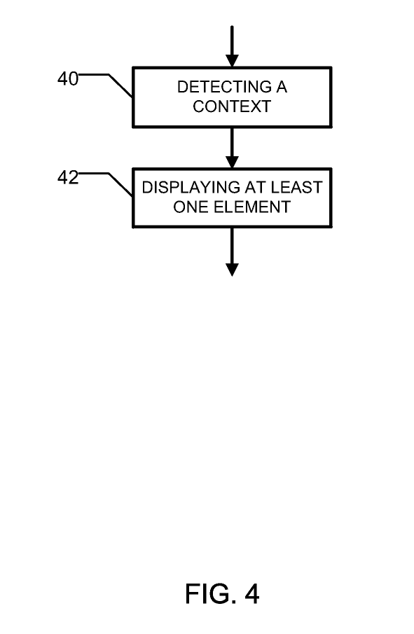

Now referring to FIG. 4, there is shown an embodiment of a method for displaying at least one element on a desktop operatively connected to a computer.

According to processing step 40, a context is detected.

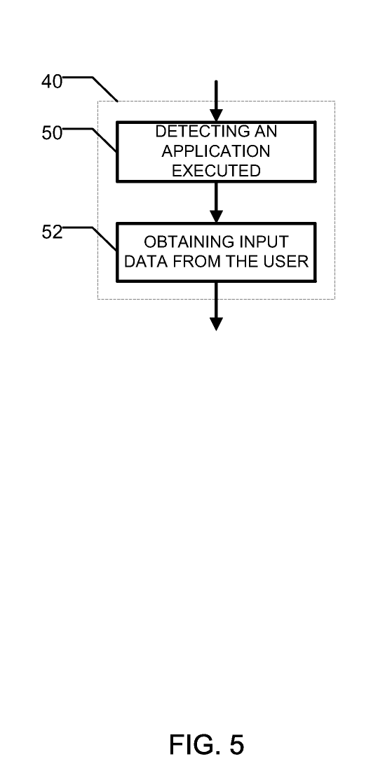

Now referring to FIG. 5, there is shown how a context is detected according to one embodiment.

According to processing step 50, an application being executed on the computer is detected.

According to processing step 52, input data is obtained from a user. It will be appreciated that the input data obtained from the user may be obtained using at least one of a keyboard and a mouse. The skilled addressee will appreciate that various alternative embodiments may be possible.

It will be appreciated that in an alternative embodiment, the context is not related to an application per se. In fact, it will be appreciated that the context may be determined using at least one parameter. The at least one parameter may be selected from a group consisting of a time of the day, a date, a mood of a user, a surrounding environment, sensors and smart phones, Bluetooth equipped devices.

According to processing step 42, at least one element is displayed on the desktop.

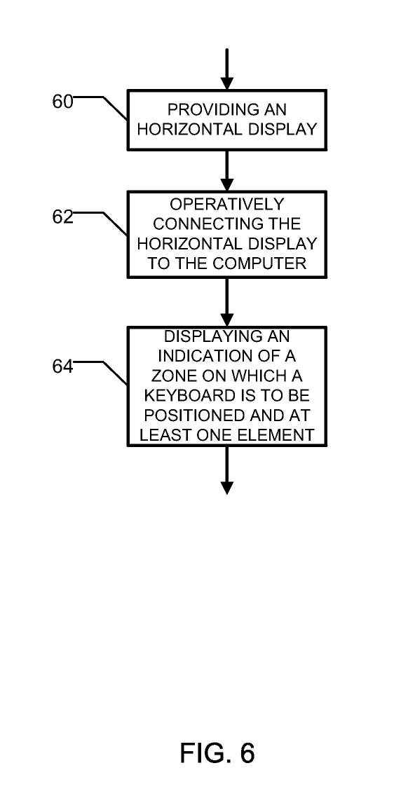

Now referring to FIG. 6, there is shown an embodiment of a method for providing a desktop operatively connected to a computer.

According to processing step 60, a horizontal display is provided. The horizontal display may be of various types as explained above.

According to processing step 62, the horizontal display is operatively connected to the computer. It will be appreciated that the horizontal display is connected to the computer according to various embodiments as explained above.

According to processing step 64, an indication of a zone on which a keyboard is to be positioned and at least one element are displayed on the horizontal display.

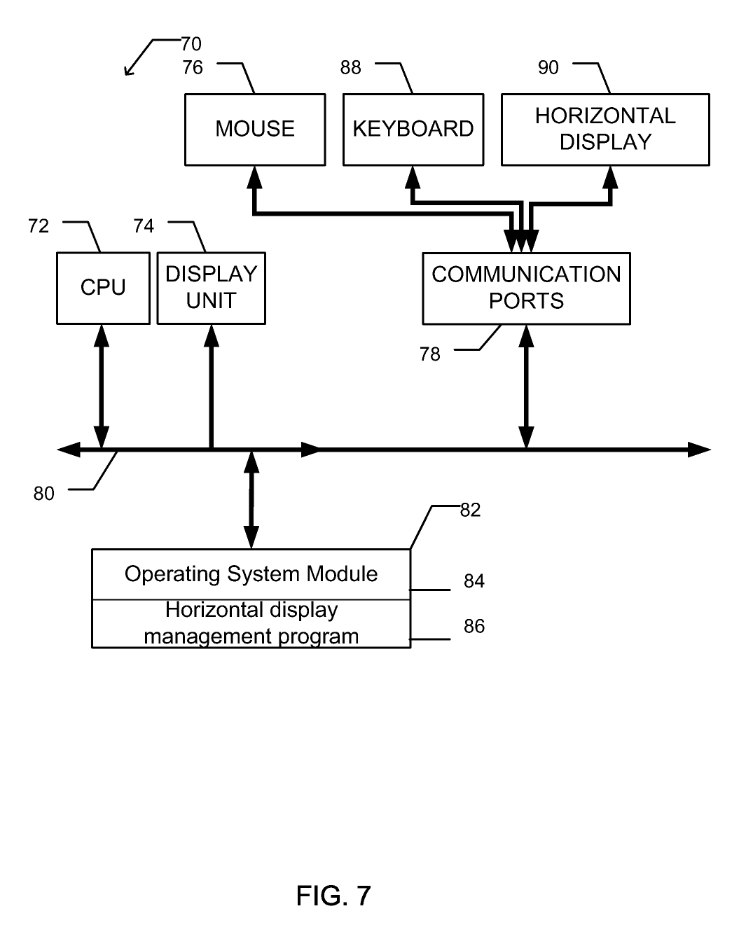

Now referring to FIG. 7, there is shown an embodiment of a computer 70 and a desktop operatively connected to the computer 70.

The computer 70, also referred to as a computing device, comprises a Central Processing Unit (CPU) 72, a display unit 74, a keyboard 76, communication ports 78, a data bus 80 and a memory 82.

The Central Processing Unit 72, the display unit 74, the communication ports 78 and the memory 82 are connected together using the data bus 110.

In a preferred embodiment, the computer 70 is a standard Windows 7 desktop PC with an ATI™ GPU acceleration card having two video outputs. Still in this embodiment the Central Processing Unit 72 is i7 manufactured by Intel™ and is running at 2.6 GHz.

Still in this embodiment, the display unit 74 comprises a LCD display, an example of which is a Samsung™ LED panel having a 23 inch width and a resolution of 1920×1080 pixels.

The communication ports 78 are used for providing data to the computer 70.

In this embodiment, a mouse 76 as well as a keyboard 88 is connected to the computer 70 via the communication ports 78. Still in this embodiment, the connection is achieved using a USB port. The skilled addressee will appreciate that various other embodiments may alternatively be provided for the communication ports 78.

It will be further appreciated that the communications ports 78 are used in this embodiment for enabling a connection with the horizontal display 90 used a desktop as explained above.

The memory 82 is used for storing data.

In this embodiment, the memory 82 has a size of 8 GB.

More precisely and still in this embodiment, the memory 82 comprises, inter alia, an operating system module 84. The operating system module 84 is Windows 7™ Home Premium Edition manufactured by Microsoft™.

The memory 84 further comprises a display signal generating unit, an embodiment of which is horizontal display management program 86. The horizontal display management program 86 is used for managing the horizontal display 90.

More precisely, the horizontal display management program 86 comprises instructions for determining a context, instructions for generating a display signal to be provided to an horizontal display 90 operatively connected to the computing device, the display signal for causing the horizontal display 90 to display a zone on which the keyboard 88 is to be positioned and at least one element wherein the at least one element is generated according to a context.

More precisely, it will be appreciated that an HTML 5 based application is used as a UI rendering engine in a preferred embodiment. The skilled addressee will appreciate that alternatively Flash™, Silverlight™, OpenGL™ or other technologies may be used for such UI rendering engine.

In addition, it will be further appreciated that in a preferred embodiment EXOscript is used for adding extensions to the HTML 5 based application in order to add contextual information. The skilled addressee will appreciate that alternatively, Microsoft™ .NET, C#, VB or any other development language associated with the OS APIs may be used. Contextual data may comprise for instance data related to a number of displays connected to the system and their respective position, a position of the mouse, a global keyboard activity, an indication of an active application and a webpage read by a user, an access to the image of all displays allowing screen captures, zoom features, a color of a pixel under the mouse, etc.

In a preferred embodiment, an application, also referred to as EXO UI, enables the user to download desktops and applications to be displayed on the horizontal display 90. The EXO UI enables the user to control the active desk, the active apps, etc. The EXO UI enables a control center to run in the display unit 74 and a desktop to run in the horizontal display unit 90.

Another application, referred to as EXO Desk, runs an HTML UI in full screen in the horizontal display unit 90.

Still in a preferred embodiment, the EXO UI and the EXO Desk applications communicate together for example to allow the user to change the active desk.

The EXO UI and the EXO Desk applications use in one embodiment Windows messages to communicate when the display unit 74 and the horizontal display 90 are connected on the same computer.

The EXO UI and the EXO Desk application may use communication standards such as RS 232, HTTP, FTP, UDP, Bluetooth and file network systems to communicate together when the display unit 74 and the horizontal display 90 are each connected on a different computer.

In fact, it should be understood by the skilled addressee that in an alternative embodiment, each of the display unit 74 and the horizontal display 90 may be associated with a different computer. This may be pertinent for instance in the case where the computer connected to the display unit 74 does not have enough processing resources for managing the horizontal display 90. In such embodiment, a dedicated computer is used for handling the horizontal display 90.

Alternative embodiments may be possible. For instance, the method disclosed above may be implemented in the operating system module 84.

Also, it will be appreciated that a computer-readable storage medium may be provided for storing computer-executable instructions. Such computer-executable instructions, when executed, would cause a computing device to perform a method for generating a display on a desktop, the desktop comprising an horizontal display operatively connected to a computer comprising a keyboard, the method comprising displaying a zone on which the keyboard is to be positioned, determining a context and displaying at least one element, wherein the at least one element is generated according to the context.

Although the above description relates to a specific preferred embodiment as presently contemplated by the inventor, it will be understood that the invention in its broad aspect includes mechanical and functional equivalents of the elements described herein.

1. A desktop to be used in combination with a computer comprising a keyboard, the desktop comprising:
a horizontal display comprising an interface for connecting the horizontal display to the computer; and
a display signal generating unit for generating a display signal to be provided to the horizontal display via the interface, the display signal for causing the horizontal display to display an indication of a zone on which the keyboard is to be positioned by a user and at least one element, wherein the at least one element is generated according to a context.

2. The desktop as claimed in claim 1, wherein the display signal generating unit comprises computer-executable instructions stored in the computer.

3. The desktop as claimed in claim 1, wherein the horizontal display is a touchscreen display.

4. The desktop as claimed in claim 1, wherein the interface is adapted for enabling a wire connection of the horizontal display to the computer.

5. The desktop as claimed in claim 4, wherein the interface comprises a USB interface.

6. The desktop as claimed in claim 1, wherein the interface is adapted for enabling a wireless connection of the horizontal display to the computer.

7. The desktop as claimed in claim 6, wherein the wireless connection is achieved using a WiFi network.

8. The desktop as claimed in claim 1, wherein the indication of a zone on which the keyboard is to be positioned by a user comprises one of a line defining the zone and a stippled line defining the zone.

9. The desktop as claimed in claim 1, wherein the indication of a zone on which the keyboard is to be positioned by a user is displayed for a given amount of time.

10. The desktop as claimed in claim 1, wherein the display signal further causes the horizontal display to display a zone on which a mouse is to be positioned.

11. The desktop as claimed in claim 1, wherein the at least one element is displayed in at least one of a plurality of zones located around the zone on which the keyboard is to be placed.

12. The desktop as claimed in claim 1, wherein the element is selected from a group consisting of applications, widgets, texts, pictures, schematics, videos, animations, RSS feeds or any combination thereof.

13. The desktop as claimed in claim 1, wherein the context is associated with the execution of an application on the computer.

14. The desktop as claimed in claim 1, wherein the context is determined using at least one parameter.

15. The desktop as claimed in claim 14, wherein the at least one parameter is selected from a group consisting of a time of the day, a date, a mood of a user, a surrounding environment, sensors and smart phones, Bluetooth equipped devices.

16. A method for providing a user with a desktop for a computer comprising a keyboard, the method comprising:
providing an horizontal display,
operatively connecting the horizontal display to the computer, and
displaying an indication of a zone on which the keyboard is to be positioned and at least one element,
wherein the at least one element is generated according to a context.

17. The method as claimed in claim 16, further comprising displaying an indication of a zone on which a mouse is to be positioned.

18. A method for displaying at least one element on a desktop operatively connected to a computer, the method comprising:
detecting a context; and
displaying at least one element on the desktop and an indication of a zone on which the keyboard is to be positioned, wherein the at least one element is generated according to a context.

19. The method as claimed in claim 18 wherein the detecting of the context comprises detecting an application being executed and obtaining input data from a user.

20. A computer-readable storage medium storing computer-executable instructions which, when executed, cause a computing device to perform a method for generating a display on a desktop, the desktop comprising an horizontal display operatively connected to a computer comprising a keyboard, the method comprising:
displaying a zone on which the keyboard is to be positioned;
determining a context; and
displaying at least one element, wherein the at least one element is generated according to the context.

21. A computing device, the computing device comprising:
a display device;
a central processing unit; and
a memory comprising at least one program, wherein the at least one program is stored in the memory and configured to be executed by the central processing unit, the at least one program comprising:
instructions for determining a context,
instructions for generating a display signal to be provided to an horizontal display operatively connected to the central processing unit, the display signal for causing the horizontal display to display a zone on which the keyboard is to be positioned and at least one element wherein the at least one element is generated according to a context.
